(19) United States
(12) Patent Application Publication
(10) Pub. No.: US 2021/0071625 A1
(43) Pub. Date: Mar. 11, 2021

(54) EGR SYSTEM

(71) Applicant: ISUZU MOTORS LIMITED, Tokyo (JP)

(72) Inventor: Ryusuke FUJINO, Fujisawa-shi, Kanagawa (JP)

(21) Appl. No.: 16/644,807

(22) PCT Filed: Sep. 4, 2018
(86) PCT No.: PCT/JP2018/032725

§ 371 Date: Mar. 5, 2020

(30) Foreign Application Priority Data
Sep. 7, 2017 (JP) 2017-171855

(51) Int. Cl. F02M 26/51; F02B 47/08; F01N 3/20; F02M 26/04

(52) U.S. Cl. CPC F02M 26/51; F02M 26/04; F01N 3/20; F02B 47/08

(57) ABSTRACT

This EGR system is applied to a vehicle including an exhaust purification device capable of purifying NOx, and is provided with: an EGR passageway; a flow volume modification mechanism; and a control device which, when the NOx concentration in exhaust discharged from the exhaust purification device is greater than a reference value, starts to perform a control process for controlling the flow volume modification mechanism so that the ratio of the flow volume of a first exhaust that flows into a tail pipe decreases and the ratio of the flow volume of a second exhaust that flows into the EGR passageway increases, and makes the ratio of the flow volume of the second exhaust greater than the ratio of the flow volume of the first exhaust during the control process.

### TECHNICAL FIELD

The present disclosure relates to an EGR system.

### BACKGROUND ART

An Exhaust Gas Recirculation (EGR) system is known (for example, see Patent Literature 1 and Patent Literature 2). The EGR system is applied to a vehicle having an exhaust purification device which enables to purify NOx. The exhaust purification device is provided in a part of an exhaust passage of an engine. The part is located further on an upstream side in an exhaust flow direction than a tail pipe portion. Specifically, the EGR system includes an EGR passage which introduces a part of exhaust gas discharged from the exhaust purification device into an intake passage of the engine, and an EGR valve arranged in the EGR passage.

### CITATION LIST

### Patent Document

Patent Literature 1: JP-A-2010-281284

Patent Literature 2: JP-A-2015-172339

### SUMMARY OF THE INVENTION

### Technical Problem

For example, when any problem occurs in the exhaust purification device, for example, the NOx purification performance of the exhaust purification device may be lower than originally expected. Thus, in a case where the NOx purification performance of the exhaust purification device is reduced, the NOx concentration in the exhaust gas discharged from the exhaust purification device becomes larger than a reference value. As a result, the NOx concentration in the exhaust gas discharged from the tail pipe to the atmosphere also becomes higher than the reference value.

An object of the present disclosure is to provide an EGR system which enables to reduce a NOx concentration in exhaust gas discharged from a tail pipe to the atmosphere even in a case where the NOx concentration in exhaust gas discharged from an exhaust purification device becomes larger than a reference value.

### Solution to Problem

An EGR system of the present invention is an EGR system applied to a vehicle including an exhaust purification device which enables to purify NOx, the exhaust purification device being provided in a part of an exhaust passage of an engine, the part being located further on an upstream side in an exhaust flow direction than a tail pipe, the EGR system includes an EGR passage that introduces a part of exhaust gas discharged from the exhaust purification device into an intake passage of the engine, a flow rate change mechanism that changes a ratio between a flow rate of a first exhaust gas discharged from the exhaust purification device and flowing into the tail pipe and a flow rate of a second exhaust gas discharged from the exhaust purification device and flowing into the EGR passage, and a control device that starts execution of a control process for controlling the flow rate change mechanism such that a ratio of a flow rate of the first exhaust gas flowing into the tail pipe decreases and a ratio of a flow rate of the second exhaust gas flowing into the EGR passage increases in a case where a NOx concentration in the exhaust gas discharged from the exhaust purification device is higher than a preset reference value, and sets the ratio of the flow rate of the second exhaust gas flowing into the EGR passage to be greater than the ratio of the flow ratio of the first exhaust gas flowing into the tail pipe during the control process.

### Advantageous Effects of the Invention

According to the EGR system of the present disclosure, even in a case where the NOx concentration in the exhaust gas discharged from the exhaust purification device is higher than the preset reference value, the NOx concentration in exhaust gas discharged from the tail pipe to the atmosphere can be reduced.

### BRIEF DESCRIPTION OF THE DRAWINGS

FIG. 1 is a configuration diagram schematically illustrating a schematic configuration of a vehicle according to an embodiment of the present disclosure.

FIG. 2 is a flowchart for explaining a tail pipe flow rate reduction control process.

### DESCRIPTION OF EMBODIMENTS

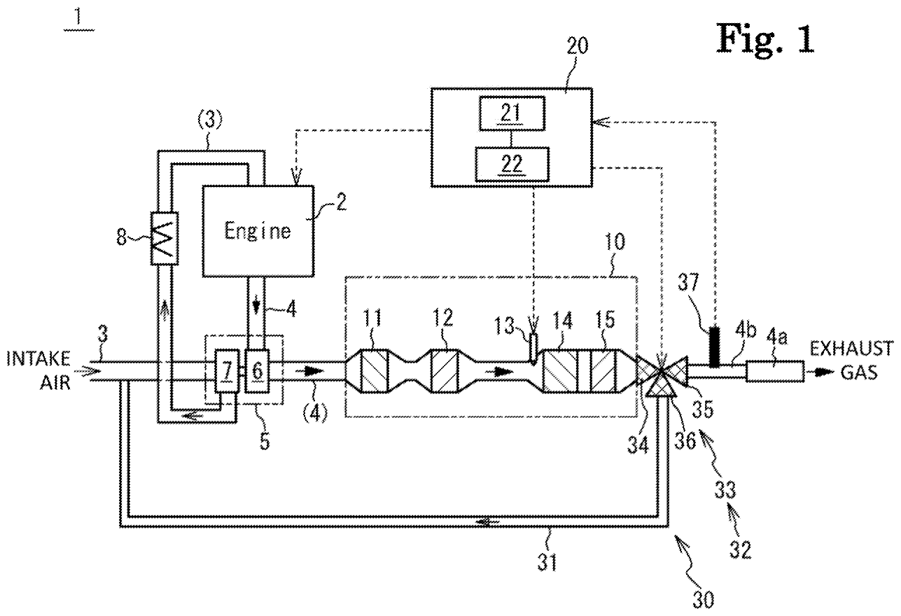

A schematic configuration of a vehicle 1 to which an EGR system 30 according to an embodiment of the present disclosure is applied will be described, and then the EGR system 30 according to the embodiment will be described. FIG. 1 is a configuration diagram schematically illustrating a schematic configuration of the vehicle 1. Although the type of the vehicle 1 is not particularly limited, in the embodiment, a commercial vehicle such as a truck or a bus is used as an example.

The vehicle 1 includes an engine 2, an intake passage 3, an exhaust passage 4, a turbocharger 5, an intercooler 8, an exhaust purification device 10, a control device 20, and the EGR system 30. Although the specific type of the engine 2 is not particularly limited, a diesel engine is used as an example in the embodiment. The intake passage 3 is a passage through which intake air taken into the engine 2 passes. The exhaust passage 4 is a passage through which the exhaust gas discharged from the engine 2 passes. The downstream end of the exhaust passage 4 is formed by a tail pipe 4a.

The turbocharger 5 is a device which supercharges the intake air of the engine 2 using the energy of the exhaust gas of the engine 2. Specifically, the turbocharger 5 includes a turbine 6 arranged in the exhaust passage 4 and a compressor 7 arranged in the intake passage 3. The compressor 7 is connected to the turbine 6 so as to rotate integrally with the turbine 6. When the turbine 6 receives the energy of the exhaust gas from the exhaust passage 4 and rotates, the compressor 7 connected to the turbine 6 also rotates. By the rotation of the compressor 7, the intake air in the intake passage 3 is supercharged.

The intercooler 8 is a heat exchanger which cools intake air supercharged by the compressor 7 by exchanging heat with refrigerant. The intercooler 8 prevents the temperature of the intake air taken into the engine 2 from becoming extremely high.

The exhaust purification device 10 is arranged on a part of the exhaust passage 4, which is the portion located further on an upstream side than the tail pipe 4a in an exhaust flow direction. Specifically, the exhaust purification device 10 according to the embodiment is arranged in a part of the exhaust passage 4, which is the portion located further on the upstream side than the tail pipe 4a and a downstream side than the turbine 6.

The exhaust purification device 10 is an exhaust purification device which can purify NOx in exhaust gas. Specifically, the exhaust purification device 10 according to the embodiment is an exhaust purification device which can also collect PM in exhaust gas and purify NOx. More specifically, the exhaust purification device 10 according to the present embodiment includes an oxidation catalyst 11, a filter 12, a urea water injection valve 13, an SCR catalyst 14, and an ammonia slip catalyst 15. The oxidation catalyst 11, the filter 12, the SCR catalyst 14, and the ammonia slip catalyst 15 are arranged in the exhaust passage 4 in this order. Further, the urea water injection valve 13 is arranged at a portion located further on the upstream side than the SCR catalyst 14 and the downstream side than the filter 12.

The filter 12 has a function of collecting PM in the exhaust gas. The oxidation catalyst 11 has a configuration in which a noble metal catalyst such as platinum (Pt) or palladium (Pd) is supported on a carrier through which exhaust gas can pass. The oxidation catalyst 1 promotes an oxidation reaction which changes nitrogen monoxide (NO) in the exhaust gas into nitrogen dioxide (NO₂) by the oxidation catalytic action of the noble metal catalyst. In a case where the exhaust temperature becomes equal to or higher than the activation temperature of the oxidation catalyst 11, with the nitrogen dioxide generated in the oxidation catalyst 11, the PM trapped in the filter 12 can be burned and discharged as carbon dioxide (CO₂).

The SCR catalyst 14 is a catalyst which selectively reduces NOx in exhaust gas using ammonia (NH₃) generated by hydrolysis of urea water injected from the urea water injection valve 13. The specific type of the catalyst is not particularly limited. For example, a known SCR catalyst such as vanadium, molybdenum, tungsten, or zeolite can be used. The ammonia slip catalyst 15 is an oxidation catalyst which oxidizes ammonia which has passed through the SCR catalyst 14.

The urea water injection valve 13 injects urea water in response to an instruction from the control device 20 described below. The urea in the urea water injected into the exhaust gas from the urea water injection valve 13 is hydrolyzed by the heat of the exhaust gas, and as a result, ammonia is generated. This ammonia reduces NOx under the catalytic action of the SCR catalyst 14. As a result, nitrogen and water are generated. In this way, purification of NOx in exhaust gas is achieved.

The control device 20 includes a microcomputer having a CPU 21 having a function as a control unit for executing various control processes and a storage unit 22 for storing various information and programs used for the operation of the CPU 21. In addition, as the storage unit 22, for example, a ROM or a RAM can be used.

The control device 20 controls the operation of the engine 2 by controlling the fuel injection timing or the fuel injection amount of the engine 2. Further, the control device 20 controls the operation of the exhaust purification device 10 by controlling the urea water injection timing or the urea water injection amount of the urea water injection valve 13. The control device 20 also controls the operation of the EGR system 30 by controlling the operation of a flow rate change mechanism 32 of the EGR system 30 described below.

The EGR system 30 includes an EGR passage 31, the flow rate change mechanism 32, and a NOx sensor 37 and also includes the control device 20 for controlling the flow rate change mechanism 32 as a part of its components.

The EGR passage 31 is a passage for introducing a part of the exhaust gas discharged from the exhaust purification device 10 into the intake passage 3 of the engine 2. The exhaust gas passing through the EGR passage 31 is referred to as EGR gas. The upstream end (the EGR gas inlet portion of the EGR passage 31) of the EGR passage 31 according to the present embodiment communicates with a second outlet portion 36 of a three-way valve 33 described below. Further, the downstream end (the EGR gas outlet of the EGR passage 31) of the EGR passage 31 according to the present embodiment communicates with a part of the intake passage 3, which is the portion located further on the upstream side than the compressor 7.

The flow rate change mechanism 32 is a mechanism for changing a ratio between a flow rate (mm³/s) of the first exhaust gas discharged from the exhaust purification device 10 and flowing into the tail pipe 4a and a flow rate (mm³/s) of the second exhaust gas discharged from the exhaust purification device 10 and flowing into the EGR passage 31. In the embodiment, the three-way valve 33 is used as an example of the flow rate change mechanism 32.

Specifically, the three-way valve 33 includes an inlet portion 34 into which exhaust gas exhausted from the exhaust purification device 10 flows, a first outlet portion through which the exhaust gas flowing from the inlet portion 34 flows out and which communicates with the exhaust inlet portion of the tail pipe 4a, and the second outlet portion 36 through which the exhaust gas flowing from the inlet portion 34 flows out and which communicates with the EGR gas inlet portion of the EGR passage 31. The three-way valve 33 changes the opening ratio of the first outlet portion 35 and the opening ratio of the second outlet portion 36 by being controlled by the control device 20, in such a manner that the three-way valve 33 changes the ratio between the flow rate of the first exhaust gas flowing from the inlet portion 34 and flowing out from the first outlet portion and the flow rate of the second exhaust gas flowing from the inlet portion 34 and flowing out from the second outlet portion 36.

In the embodiment, the inlet portion 34 of the three-way valve 33 is directly connected to the exhaust outlet portion of the exhaust purification device 10. However, the invention is not limited to this configuration. For example, the inlet portion 34 may be connected to the exhaust outlet portion of the exhaust purification device 10 via another piping member. The first outlet portion 35 of the three-way valve 33 is connected to the exhaust inlet portion of the tail pipe 4a via an exhaust pipe 4b. However, the invention is not limited to this configuration. For example, the first outlet portion 35 may be directly connected to the exhaust inlet portion of the tail pipe 4a. The second outlet portion 36 of the three-way valve 33 is directly connected to the EGR gas inlet portion of the EGR passage 31. However, the invention is not limited to this configuration. The second outlet portion 36 may be connected to the EGR gas inlet portion of the EGR passage 31 via another piping member.

When a specific example as the other example of the flow rate change mechanism 32 other than the three-way valve 33 is given, for example, a configuration including a first flow rate regulating valve disposed in the exhaust pipe 4b and a second flow rate regulating valve disposed in the EGR passage 31 may be adopted as an example of the flow rate change mechanism 32. In this case, by changing the opening ratio of each of the first flow rate regulating valve and the second flow rate regulating valve, the control device 20 can change the ratio between the flow rate of the exhaust gas flowing into the tail pipe 4 a and the flow rate of the exhaust gas flowing into the EGR passage 31.

However, by using the three-way valve 33 as the flow rate change mechanism 32 as in the embodiment, the configuration of the flow rate change mechanism 32 can be simplified. In this regard, it is preferable to use the three-way valve 33 as the flow rate change mechanism 32.

The NOx sensor 37 detects the NOx concentration in the exhaust gas discharged from the exhaust purification device 10 and transmits the detection result to the control device 20. The specific arrangement position of the NOx sensor 37 is not particularly limited as long as it has such a function. However, as an example, the NOx sensor 37 according to the embodiment is disposed in a part of the exhaust pipe 4b between the first outlet portion 35 of the three-way valve 33 and the tail pipe 4a. In addition, as another example of the arrangement position of the NOx sensor 37, for example, the NOx sensor 37 may be arranged at a portion between the inlet portion 34 of the three-way valve 33 and the ammonia slip catalyst 15.

Next, control of the flow rate change mechanism 32 by the control device 20 will be described. When the NOx concentration in the exhaust gas discharged from the exhaust purification device 10 is equal to or less than a preset reference value (this is referred to as “normal case”), based on a preset EGR gas flow rate map, the control device executes a control process (hereinafter, referred to as “normal control process”) for controlling the flow rate change mechanism 32 so as to obtain a predetermined EGR gas flow rate.

In the normal control process, the control device 20 controls the flow rate change mechanism 32 such that the ratio (hereinafter, simply referred to as “the ratio of the flow rate of the first exhaust gas”.) of the flow rate of the first exhaust gas discharged from the exhaust purification device 10 and flowing into the tail pipe 4a to the flow rate of the exhaust gas discharged from the exhaust purification device 10 becomes larger than the ratio (hereinafter, simply referred to as “the ratio of the flow rate of the second exhaust gas.”) of the flow rate (the EGR gas flow rate of the EGR passage 31) of the second exhaust gas discharged from the exhaust purification device 10 and flowing into the EGR passage 31 to the flow rate of the exhaust gas discharged from the exhaust purification device 10. That is, in a case where the ratio of the flow rate of the first exhaust gas flowing into the tail pipe 4a is defined as A % and the ratio of the flow rate of the second exhaust gas flowing into the EGR passage 31 is defined as B % (B %=100%−A %), in the normal control process, the relationship “A>B” is satisfied. In this case, B may be 0%.

On the other hand, in a case where the NOx concentration in the exhaust gas discharged from the exhaust purification device 10 is higher than the preset reference value, the control device 20 stops execution of the normal control process, and instead, starts execution of a control process (hereinafter referred to as “tail pipe flow rate reduction control process”) for controlling the flow rate change mechanism 32 such that the ratio (A %) of the flow rate of the first exhaust gas discharged from the exhaust purification device 10 and flowing into the tail pipe 4a decreases and the ratio (B %) of the flow rate of the second exhaust gas discharged from the exhaust purification device and flowing into the EGR passage 31 increases. Further, in the tail pipe flow rate reduction control process, the control device 20 controls the flow rate change mechanism 32 such that the ratio of the flow rate of the second exhaust gas flowing into the EGR passage 31 becomes greater than the ratio of the flow rate of the first exhaust gas flowing into the tail pipe 4a. The details of the tail pipe flow rate reduction control process will be described below with reference to a flowchart.

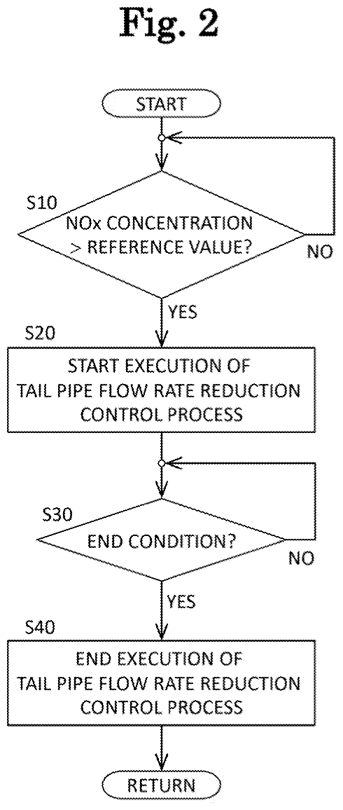

FIG. 2 is a flowchart for explaining the tail pipe flow rate reduction control process. Each step in FIG. 2 is specifically executed by the CPU 21 of the control device 20. At the time of the first start in FIG. 2, the execution of the normal control process has already been started. As a result, at the time of the first start, it is assumed that the flow rate change mechanism 32 sets the ratio of the flow rate of the first exhaust gas flowing into the tail pipe 4a to be greater than the ratio of the flow rate (EGR gas flow rate) of the second exhaust gas flowing into the EGR passage 31.

In Step S10, the control device 20 determines whether the NOx concentration in the exhaust gas discharged from the exhaust purification device 10 is higher than the preset reference value. Specifically, this reference value is stored in the storage unit 22 of the control device 20 in advance. The control device 20 acquires the detection result of the NOx sensor 37, thereby acquiring the NOx concentration in the exhaust gas discharged from the exhaust purification device 10. Then, the control device 20 executes Step S10 by determining whether the NOx concentration acquired in this manner is higher than the reference value of the storage unit 22.

Although the specific value of the reference value according to Step S10 is not particularly limited, for example, an upper limit value (that is, an exhaust gas regulation value) of the NOx concentration specified by law may be used or a value smaller than the exhaust gas regulation value by a predetermined value (for example, several percent) may be used. In the embodiment, an exhaust gas regulation value is used as an example of the reference value.

Step S10 is repeatedly executed until it is determined as YES. In a case where it is determined as YES in Step S10, the control device 20 stops the execution of the normal control process, and instead starts the execution of the tail pipe flow reduction control process (Step S20).

Specifically, in Step S20, the control device 20 controls the three-way valve 33 such that the ratio of the flow rate of the first exhaust gas flowing out from the first outlet portion 35 of the three-way valve 33 becomes smaller than the ratio of the flow rate of the first exhaust gas at the time when YES is determined in Step S10 and the ratio of the flow rate of the second exhaust gas flowing out from the second outlet portion 36 is increased so as to be greater than the ratio of the flow rate of the second exhaust gas at the time when YES is determined in Step S10. Therefore, the ratio (A %) of the flow rate of the first exhaust gas flowing into the tail pipe 4a decreases and the ratio (B %) of the flow rate of the second exhaust gas flowing into the EGR passage 31 increases by the decrease in the exhaust gas flow rate ratio.

In this tail pipe flow rate reduction control process, the control device 20 controls the three-way valve 33 so that the ratio of the flow rate of the second exhaust gas flowing out from the second outlet portion 36 becomes greater than the ratio of the flow rate of the first exhaust gas flowing out from the first outlet portion 35 of the three-way valve 33, in such a manner that the ratio (B %) of the flow rate of the second exhaust gas flowing into the EGR passage 31 is made larger than the ratio (A %) of the flow rate of the first exhaust gas flowing into the tail pipe 4a. That is, in Step S20, the control device 20 controls the three-way valve 33 so that the relationship “A<B” is satisfied.

In addition, although the specific numerical ranges of the “ratio (A %) of the flow rate of the first exhaust gas flowing into the tail pipe 4a” and the “ratio (B %) of the flow rate of the second exhaust gas flowing into the EGR passage 31” in Step S20 are not particularly limited, as an example, the control device 20 according to the embodiment controls the three-way valve 33 so that “A:B=1:n (where n is a numerical value satisfying 1<n≤9)”. That is, the control device 20 sets B % to be larger than A % within a range in which B % is nine times the maximum of A %. However, this is only an example of a numerical value and the invention is not limited to this numerical example.

In Step S20, the control device 20 preferably controls the three-way valve 33 so that the larger the NOx concentration detected by the NOx sensor 37, the larger the ratio (B %) of the flow rate of the second exhaust gas flowing into the EGR passage 31 and the smaller the ratio (A %) of the flow rate of the first exhaust gas flowing into the tail pipe 4a. As a specific example, for example, it is assumed that, in a case where the detection value of the NOx sensor 37 is “C1”, the ratio of the flow rate of the second exhaust gas flowing into the EGR passage 31 is “B1” and the ratio of the flow rate of the first exhaust gas flowing into the tail pipe 4a is “A1”. In this case, when the detection value of the NOx sensor 37 becomes “C2 (this is a value larger than C1)”, the control device 20 sets the ratio of the flow rate of the second exhaust gas flowing into the EGR passage 31 to “B2 (which is a value larger than B1)” and sets the ratio of the flow rate of the first exhaust gas flowing into the tail pipe 4a to “A2 (which is a value smaller than A1)”.

After Step S20, the control device 20 determines whether a condition (“end condition”) for terminating the execution of the tail pipe flow rate reduction control process is satisfied (Step S30). Although the specific contents of the termination condition are not particularly limited, in the embodiment, as an example, a condition that the NOx concentration in the exhaust gas discharged from the exhaust purification device becomes equal to or less than the preset reference value is used.

Specifically, the control device 20 acquires the NOx concentration by acquiring the detection result of the NOx sensor 37 in Step S30. The control device 20 determines whether the NOx concentration obtained in this manner is a value equal to or less than the reference value stored in the storage unit 22. Then, in a case where it is determined that the NOx concentration is equal to or less than the reference value, the control device determines that the termination condition is satisfied (YES). This reference value is the same value as the reference value in Step S10. Step S30 is repeatedly executed until it is determined to be YES.

In a case where it is determined as YES in Step S30, the control device 20 ends the execution of the tail pipe flow rate reduction control process (Step S40). Specifically, the control device 20 ends the execution of the tail pipe flow rate reduction control process by returning the state of the three-way valve 33 as the flow rate change mechanism 32 to the state immediately before the start of the execution of Step S20, and instead, the execution of the normal control process is restarted. As a result, the ratio (A %) of the flow rate of the first exhaust gar flowing into the tail pipe 4a becomes larger than the ratio (B %) of the flow rate of the second exhaust gas flowing into the EGR passage 31. After the execution of Step S40, the control device 20 executes the flowchart again from the start (return).

The operation effects of the EGR system 30 according to the embodiment as described above are summarized as follows. According to the embodiment, in a case where the NOx concentration in the exhaust gas discharged from the exhaust purification device 10 is higher than the preset reference value (in the case of YES in Step S10), the execution of the tail pipe flow rate reduction control process is started in Step S20. Therefore, by reducing the ratio of the flow rate of the first exhaust gas discharged from the exhaust purification device 10 and flowing into the tail pipe 4a, the ratio of the flow rate of the second exhaust gas flowing into the EGR passage 31 can be increased. Thereby, the NOx concentration in the exhaust gas discharged from the tail pipe 4a to the atmosphere can be reduced.

In this tail pipe flow rate reduction control process, the EGR system 30 controls the flow rate change mechanism 32 so that the ratio of the flow rate of the second exhaust gas flowing into the EGR passage 31 becomes larger than the ratio of the flow rate of the first exhaust gas flowing into the tail pipe 4a. Therefore, the NOx concentration in the exhaust gas discharged from the tail pipe 4a to the atmosphere can be effectively reduced. As a result, the NOx concentration in the exhaust gas discharged from the tail pipe 4a to the atmosphere can be effectively reduced to the reference value or less.

As described above, according to the embodiment, even in a case where the NOx concentration in the exhaust gas discharged from the exhaust purification device 10 becomes larger than the reference value, the NOx concentration in the exhaust gas discharged from the tail pipe 4a to the atmosphere can be effectively reduced to the reference value or less. Therefore, for example, even in a case where some problem occurs in the exhaust purification device 10 and the NOx purification performance of the exhaust purification device 10 is lower than expected, it is possible to effectively suppress emission of the exhaust gas having a NOx concentration higher than the reference value (in the embodiment, as an example, an exhaust gas regulation value) to the atmosphere. That is, even in a case where some problem occurs in the exhaust purification device 10 and the NOx purification performance of the exhaust purification device 10 is lower than expected, the NOx concentration in the exhaust gas discharged to the atmosphere can be adjusted to the emission gas regulation value.

Although the preferred embodiment of the present disclosure has been described above, the present disclosure is not limited to such specific embodiment and various modifications and changes can be made within the scope of the present disclosure described in the claims.

This application is based on a Japanese patent application (Patent Application No. 2017-171855) filed on Sep. 7, 2017, the contents of which are incorporated herein by reference.

### INDUSTRIAL APPLICABILITY

The EGR system of the present disclosure is useful in that it reduces the NOx concentration in the exhaust gas discharged from the tail pipe to the atmosphere even in a case where the NOx concentration in the exhaust gas discharged from the exhaust purification device is higher than a preset reference value.

### LIST OF REFERENCE NUMERALS

1 vehicle
2 engine
3 intake passage
4 exhaust passage
4a tail pipe
5 turbocharger
10 exhaust purification device
20 control device
30 EGR system
31 EGR passage
32 flow rate change mechanism
33 three-way valve
34 inlet portion
35 first outlet portion
36 second outlet portion
37 NOx sensor

1. An EGR system applied to a vehicle including an exhaust purification device which enables to purify NOx, the exhaust purification device being provided in a part of an exhaust passage of an engine, the part being located further on an upstream side in an exhaust flow direction than a tail pipe, the EGR system comprising:
an EGR passage that introduces a part of exhaust gas discharged from the exhaust purification device into an intake passage of the engine;
a flow rate change mechanism that changes a ratio between a flow rate of a first exhaust gas discharged from the exhaust purification device and flowing into the tail pipe and a flow rate of a second exhaust gas discharged from the exhaust purification device and flowing into the EGR passage; and
a control device that starts execution of a control process for controlling the flow rate change mechanism such that a ratio of a flow rate of the first exhaust gas flowing into the tail pipe decreases and a ratio of a flow rate of the second exhaust gas flowing into the EGR passage increases in a case where a NOx concentration in the exhaust gas discharged from the exhaust purification device is higher than a preset reference value, and sets the ratio of the flow rate of the second exhaust gas flowing into the EGR passage to be greater than the ratio of the flow ratio of the first exhaust gas flowing into the tail pipe during the control process.

2. The EGR system according to claim 1,
wherein a three-way valve is configured as the flow rate change mechanism,
the three-way valve includes:
an inlet portion into which the exhaust gas discharged from the exhaust purification device flows;
a first outlet portion through which exhaust gas flowed in from the inlet portion flows out, and which communicates with an exhaust inlet portion of the tail pipe; and
a second outlet portion through which exhaust gas flowed in from the inlet portion flows out, and which communicates with an EGR gas inlet portion of the EGR passage, and
a ratio between a flow rate of exhaust gas which is flowed in from the inlet portion and flows out from the first outlet portion and a flow rate of exhaust gas which is flowed in from the inlet portion and flows out from the second outlet portion is changed due to the control process by the control device.
